(19) United States
(12) Patent Application Publication
(10) Pub. No.: US 2025/0362939 A1
(43) Pub. Date: Nov. 27, 2025

(54) SYSTEMS AND METHODS FOR REAL-TIME ANALYTICS DASHBOARD GENERATION BASED ON USER BEHAVIOR DATA

(71) Applicants: SUKESH REDDY TUMMURI, HYDERABAD (IN); SAIDYA RAMANI ALLA, HYDERABAD (IN)

(72) Inventors: SUKESH REDDY TUMMURI, HYDERABAD (IN); SAIDYA RAMANI ALLA, HYDERABAD (IN)

(21) Appl. No.: 19/293,647

(22) Filed: Aug. 7, 2025

(30) Foreign Application Priority Data
Jun. 5, 2025 (IN) 202541054220

(51) Int. Cl. G06F 9/451; G06F 11/34; G06F 21/62

(52) U.S. Cl. CPC G06F 9/451; G06F 11/3438; G06F 21/6245

(57) ABSTRACT

A method for real-time generation of a personalized analytics dashboard based on user behavior data is disclosed. The method includes continuously receiving, at a behavior modeling engine, user interaction data from an interactive digital platform. The method includes analyzing the user interaction data in real time. The method includes determining a contextual relevance score for each of a plurality of predefined dashboard components. The method includes selecting a subset associated with the plurality of predefined dashboard components based on the determined contextual relevance score and a user profile. The method includes dynamically assembling the personalized analytics dashboard. The method includes rendering the personalized analytics dashboard for display to a user via a graphical user interface. The method includes receiving one or more feedback signals based on user interactions with the displayed personalized analytics dashboard. The method includes updating the behavior modeling engine and the user profile.

### CROSS-REFERENCE TO RELATED APPLICATIONS

This patent application claims priority benefit of Indian Non-Provisional patent application No. 202541054220, titled SYSTEMS AND METHODS FOR REAL-TIME ANALYTICS DASHBOARD GENERATION BASED ON USER BEHAVIOR DATA, filed on 5 Jun. 2025.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to field of real-time user interface customization and data analytics. More particularly, to systems and methods for real-time analytics dashboard generation based on user behavior data.

### BACKGROUND OF THE INVENTION

In conventional analytics systems, dashboards are often statically configured with predefined charts, key performance indicators (KPIs), and visual layouts regardless of the user's individual needs, preferences, or behavior. Static dashboards typically present an overwhelming amount of information, some of which are irrelevant to the current user context, thereby reducing usability and engagement.

Some prior art systems offer limited personalization based on stored user preferences or role-based templates. However, conventional methods generally rely on manually defined rules or user selections rather than real-time behavioral inference. Moreover, the conventional methods do not continuously adapt to evolving interaction patterns or provide responsiveness to session-level feedback.

Existing analytics platforms also lack mechanisms for intelligent component prioritization and layout adaptation based on inferred user intent. The static dashboards require full rendering of all visual elements before user interaction is possible, leading to increased load time and delayed insights.

Furthermore, privacy concerns arise when collecting detailed user behavior data, especially in centralized analytics environments. The existing analytics platforms often do not employ privacy-preserving mechanisms such as federated learning or differential privacy techniques to protect sensitive user data during behavioral modeling.

Accordingly, there is a need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for real-time generation of a personalized analytics dashboard based on user behavior data is disclosed. The method includes continuously receiving, at a behavior modeling engine, user interaction data from an interactive digital platform. The interaction data comprises at least one user navigation pattern, at least one user input activity, and a dwell time metric associated with one or more graphical user interface elements. The method includes analyzing, by the behavior modeling engine, the user interaction data in real time, wherein the behavior modelling engine comprising at least one machine learning model trained to identify user intent and engagement level. The method includes determining a contextual relevance score for each of a plurality of predefined dashboard components based on the analyzed user interaction data. The method includes selecting a subset associated with the plurality of predefined dashboard components based on the determined contextual relevance score and a user profile. Upon selecting the subset, the method includes dynamically assembling the personalized analytics dashboard. The method includes rendering the personalized analytics dashboard for display to a user via a graphical user interface. The method includes receiving one or more feedback signals based on user interactions with the displayed personalized analytics dashboard. The method includes updating the behavior modeling engine and the user profile based on the received one or more feedback signals.

In accordance with another embodiment of the present disclosure, a system for real-time generation of a personalized analytics dashboard based on user behavior data is disclosed. The system includes at least one memory and at least one processor operatively connected to the at least one memory. The at least one processor is configured to continuously receive, at a behavior modeling engine, user interaction data from an interactive digital platform. The interaction data comprises at least one user navigation pattern, at least one user input activity, and a dwell time metric associated with one or more graphical user interface elements. The at least one processor is configured to analyze the user interaction data in real time using the behavior modeling engine. The behavior modelling engine comprising at least one machine learning model trained to identify user intent and engagement level. The at least one processor is configured to determine a contextual relevance score for each of a plurality of predefined dashboard components based on the analyzed user interaction data. The at least one processor is configured to select a subset associated with the plurality of predefined dashboard components based on the determined contextual relevance score and a user profile. Upon selecting the subset, the at least one processor is configured to dynamically assemble a personalized analytics dashboard. The at least one processor is configured to render the personalized analytics dashboard for display to a user via a graphical user interface. The at least one processor is configured to receive one or more feedback signals based on user interactions with the displayed personalized analytics dashboard. The at least one processor is configured to update the behavior modeling engine and the user profile based on the received one or more feedback signals.

In accordance with another embodiment of the present disclosure, a non-transitory computer-readable medium storing instructions that, when executed, cause at least one processor to continuously receive, at a behavior modeling engine, user interaction data from an interactive digital platform, wherein the interaction data comprises at least one user navigation pattern, at least one user input activity, and a dwell time metric associated with one or more graphical user interface elements. The at least one processor is configured to analyze the user interaction data in real time using the behavior modeling engine. The behavior modelling engine comprising at least one machine learning model trained to identify user intent and engagement level. The at least one processor is configured to determine a contextual relevance score for each of a plurality of predefined dashboard components based on the analyzed user interaction data. The at least one processor is configured to select a subset associated with the plurality of predefined dashboard components based on the determined contextual relevance score and a user profile. Upon selecting the subset, the at least one processor is configured to dynamically assemble a personalized analytics dashboard. The at least one processor is configured to render the personalized analytics dashboard for display to a user via a graphical user interface. The at least one processor is configured to receive one or more feedback signals based on user interactions with the displayed personalized analytics dashboard. The at least one processor is configured to update the behavior modeling engine and the user profile based on the received one or more feedback signals.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram depicting an exemplary environment of real-time generation of a personalized analytics dashboard based on user behavior data, in accordance with an embodiment of the present disclosure;

FIG. 2 is a block diagram depicting a system for real-time generation of the personalized analytics dashboard based on the user behavior data, in accordance with an embodiment of the present disclosure; and

FIG. 3A-FIG. 3B illustrate a process flow diagram depicting an exemplary method for real-time generation of the personalized analytics dashboard based on user behavior data, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The present disclosure generates personalized analytics dashboards in real-time by analyzing real-time user interaction data to adaptively assemble and render relevant visual components based on inferred user behavior patterns. The present disclosure leverages machine learning-based behavior modeling, real-time relevance scoring of dashboard components, and privacy-aware processing strategies.

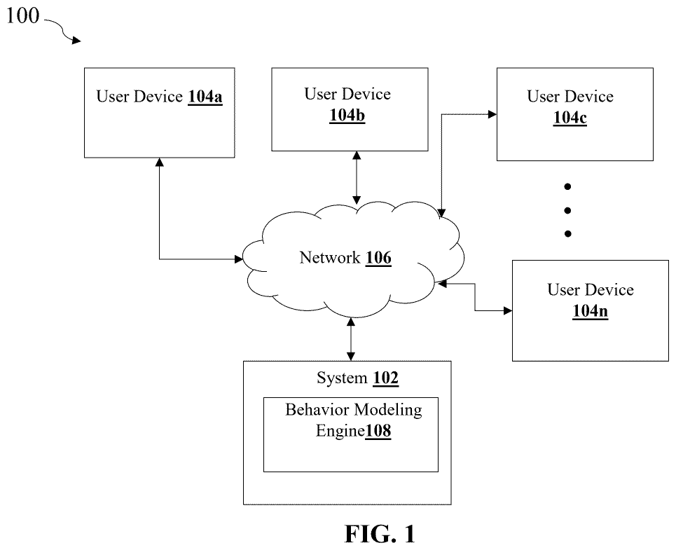

The environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram 100 depicting an exemplary environment FIG. 1 of real-time generation of a personalized analytics dashboard based on user behavior data, in accordance with an embodiment of the present disclosure.

According to FIG. 1, the exemplary environment 100 includes a system 102, a plurality of user devices 104a, 104b, 104c . . . 104n, and a network 106. The network 106 may include an internet. The network 106 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 106 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

The system 102 may include a behavior modeling engine 108. In an embodiment, the system 102 may be connected to the each of the plurality of user devices 104a, 104b, 104c . . . 104n through the network 106. In another embodiment, each of the plurality of user devices 104a, 104b, 104c . . . 104n may include the system 102. Further, in another embodiment, some part of the 102 may be externally connected to the each of the plurality of user devices 104a, 104b, 104c . . . 104n and remaining part may be implemented within the plurality of user devices 104a, 104b, 104c . . . 104n.

Each of the plurality of user devices 104a, 104b, 104c . . . 104n may refer to any computing device operated by a user that enables interaction with an interactive digital platform and facilitates the capture and transmission of user behavior data. The user behavior data may include interpreted or inferred behavioral patterns, often derived from user interaction data. The user behavior data may include, but is not limited to, engagement level, intent inference, behavioral segments or personas, and the like.

The interactive digital platform may refer to any interactive software application, website, or mobile environment through which users engage with content, services, or functionalities, and from which user interaction data may be captured for behavioral analysis.

Each of the plurality of user devices 104a, 104b, 104c . . . 104n may serve as a rendering environment for the personalized analytics dashboard generated by the system 102. Each of the plurality of user devices 104a, 104b, 104c . . . 104n may include, but is not limited to, a smartphone, a tablet, a desktop computer, a smart television, a wearable computing device, industrial or enterprise terminals, and the like.

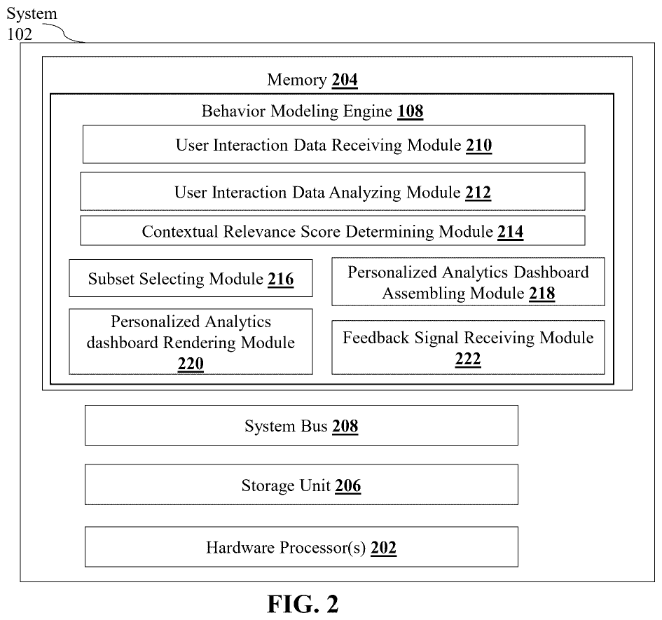

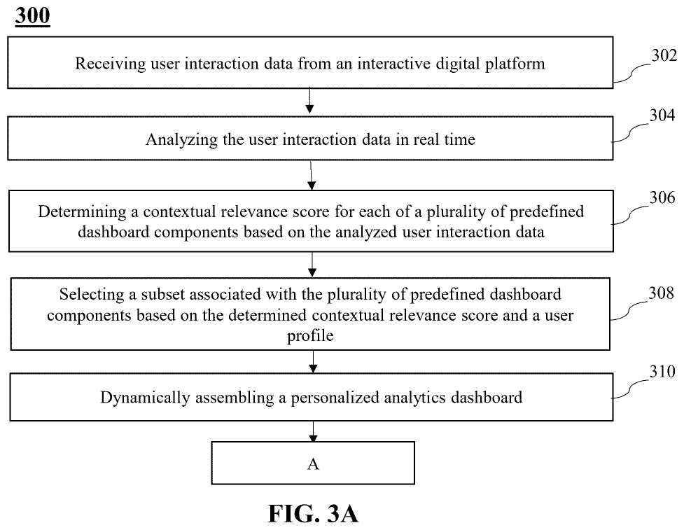

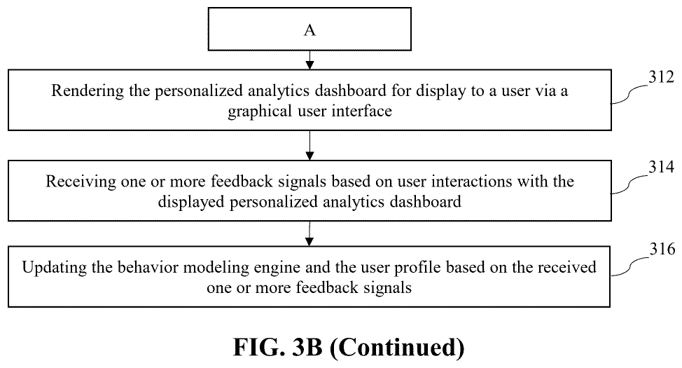

The personalized analytics dashboard may refer to a dynamically assembled graphical user interface. The dynamically assembled graphical user interface may include a selected subset of data visualization components, metrics, or insights that are tailored in real time to an individual user behavior, preferences, intent, and contextual relevance. A dashboard layout, content, and component prioritization may be adaptively determined using the behavior modeling engine 108 that analyzes interaction data captured from each of the plurality of user devices 104a, 104b, 104c . . . 104n. The system 102 may be configured to perform real-time generation of the personalized analytics dashboard based on the user behavior data. The system 102 has now been further detailed with reference to FIG. 2, FIG. 3A and FIG. 3B.

FIG. 2 is a block diagram depicting the system 102 for real-time generation of the personalized analytics dashboard based on the user behavior data, in accordance with an embodiment of the present disclosure. The system 102 may include at least one processor 202, a memory 204 and a storage unit 206. The at least one processor 202, the memory 204 and the storage unit 206 may be communicatively coupled through a system bus 208 or any similar mechanism.

The memory 204 may include the behavior modeling engine 108 in the form of programmable instructions executable by the at least one processor 202. The at least one processor 202 may indicate one or more hardware processors. In an embodiment, the at least one processor 202 may be configured to perform a plurality of operations of the behavior modeling engine 108. The plurality of operations may include, but are not limited to, receive user interaction data, analyze the user interaction data, determine a contextual relevance score, selection of a subset of a plurality of predefined dashboard components, assemble a personalized analytics dashboard, receive feedback signal, and the like.

Further, the behavior modeling engine 108 may include a user interaction data receiving module 210, a user interaction data analyzing module 212, a contextual relevance score determining module 214, a subset selecting module 216, a personalized analytics dashboard assembling module 218, a personalized analytics dashboard rendering module 220, and a feedback signal receiving module 222. The user interaction data receiving module 210, the user interaction data analyzing module 212, the contextual relevance score determining module 214, the subset selecting module 216, the personalized analytics dashboard assembling module 218, the personalized analytics dashboard rendering module 220, and the feedback signal receiving module 222 may be communicated with each other.

The user interaction data receiving module 210 may be configured to continuously receive the user interaction data generated by the user engaging with the interactive digital platform. The user interaction data may include, but is not limited to, a user navigation pattern, at least one user input activity, and a dwell time metric associated with one or more graphical user interface elements, client events, page navigation paths, and the like. In an example scenario, the user interaction data receiving module 210 receives a user's navigation flow across dashboard tabs and time spent hovering over key performance indicator (KPI) widgets.

In an embodiment, the user interaction data analyzing module 212 may be configured to analyze the user interaction data using one or more behavior modeling techniques. The one or more behavior modeling techniques may include, but are not limited to, statistical analysis and machine learning techniques, and the like. The one or more behavior modeling techniques may be configured to identify user intent and an engagement level. For example, the user interaction data analyzing module 212 infers user engagement levels, intent, interest zones, and potential drop-off patterns. In an example scenario, the user interaction data analyzing module 212 detects that the user is more engaged with predictive KPIs than with historical trend charts based on click frequency and dwell time.

In an embodiment, the contextual relevance score determining module 214 may be configured to determine the contextual relevance score for each of the plurality of predefined dashboard components. The contextual relevance score may refer to a dynamically computed value that quantifies the predicted utility, importance, or engagement likelihood of a dashboard component for a specific user session.

The contextual relevance score determining module 214 may be configured to update the contextual relevance score at predefined interaction thresholds using a streaming data pipeline. The streaming data pipeline may be configured with event-time windowing. The contextual relevance score may be derived using the behavior modeling engine 108 that analyzes real-time user interaction data, user profile attributes, session context, and historical interaction patterns. Higher scores indicate a higher probability that a given dashboard component aligns with the user's current intent or informational needs.

In an example scenario, the contextual relevance score determining module 214 assigns a higher relevance score to a sales performance graph for a regional manager who recently reviewed territory-level metrics.

The behavior modeling engine 108 may include a hybrid model architecture combining a real-time rule-based engine with a long short-term memory (LSTM) neural network to adaptively model user behavior transitions across different sessions.

In an embodiment, the subset selecting module 216 may be configured to select the subset of the plurality of predefined dashboard components from an available component pool. The selection of the subset may be customized to match the inferred user intent and engagement potential while adhering to display constraints or user preferences stored in a user profile. The user profile may dynamically incorporate micro-behaviors derived from the interaction data. The interaction data may include gesture patterns and scroll velocity. For an example scenario, the subset selecting module 216 selects 5 out of 12 components to be shown on a first screen of the personalized analytics dashboard based on a session-specific relevance.

In an embodiment, the personalized analytics dashboard assembling module 218 may be configured to dynamically assemble the selected predefined dashboard components into a cohesive, personalized dashboard layout. The personalized analytics dashboard assembling module 218 may be configured to leverages layout constraints, display weights, and container priorities to create a responsive and adaptive interface optimized for the current device and session. In an example scenario, the personalized analytics dashboard assembling module 218 arranges selected charts and KPI indicators into a grid layout, with high-priority elements rendered in larger tiles at the top.

In an embodiment, the personalized analytics dashboard rendering module 220 may be configured to render the assembled personalized analytics dashboard for display on each of the plurality of user devices 104a, 104b, 104c . . . 104n. The personalized analytics dashboard rendering module 220 may be configured to use progressive a rendering technique and prioritize rendering of high-relevance components to minimize time-to-insight and enhance interactivity. For example, the personalized analytics dashboard rendering module 220 renders top-priority components first while lower-priority components load in the background to reduce perceived latency.

The personalized analytics dashboard rendering module 220 may be configured to partitioning the plurality of predefined dashboard components into a plurality of prioritized rendering segments based on the determined contextual relevance score, and sequentially initiating the rendering of higher-priority segments prior to lower-priority segments.

In an embodiment, the personalized analytics dashboard rendering module 220 may be configured to correlate one or more detected trends associated with the user behavior data with outputs of one or more anomaly detection models trained on historical deviations in key performance indicator (KPI) patterns derived from a prior personalized analytics dashboard. Further, the personalized analytics dashboard rendering module 220 may be configured to generate a plurality of real-time alerts using a predictive insights component based on the correlated one or more detected trends associated with the user behavior data.

In an embodiment, the feedback signal receiving module 222 may be configured to capture feedback signals derived from user interactions with the personalized analytics dashboard. The one or more feedback signals may include follow-up clicks, scrolling behavior, time spent on visual components, and inferred disengagement cues. The one or more feedback signals may be used to update the behavior modeling engine 108 and refine the user profile for future sessions. In an embodiment, the one or more feedback signals may include one or more predictive disengagement indicators. The one or more predictive disengagement indicators may be generated by detecting a decrease in interaction entropy that exceeds a predefined threshold across sequential sections of the personalized analytics dashboard. For example, the feedback signal receiving module 222 detects that the user ignored a widget and uses that feedback to lower future relevance score.

In an embodiment, the behavior modeling engine 108 may be configured to assign a flexible display weight and a container priority value to each of the plurality of predefined dashboard components. The behavior modeling engine 108 may be configured to dynamically reconfigure the personalized analytics dashboard based on the flexible display weight and the container priority value.

In an embodiment, the behavior modeling engine 108 may be configured to apply an adaptive privacy mechanism that selectively injects differential privacy noise into sensitive features of the captured interaction data. The sensitive features may be identified based on real-time classification of data sensitivity levels prior to processing by the behavior modeling engine 108.

In an embodiment, the behavior modeling engine 108 may be incrementally retrain using a federated learning framework distributed across the plurality of user devices 104a, 104b, 104c . . . 104n. The behavior modeling engine 108 may be configured to compute one or more model updates on the plurality of user devices 104a, 104b, 104c . . . 104n and securely aggregate by a central server without transmitting raw interaction data.

In an embodiment, a non-transitory computer-readable medium storing instructions that, when executed, cause the at least one processor 202 to continuously receive, at the behavior modeling engine 108, the user interaction data associated with the user behavior data from the interactive digital platform. The interaction data may include the at least one user navigation pattern, the at least one user input activity, and the dwell time metric associated with the one or more graphical user interface elements.

The at least one processor 202 is configured to analyze the user interaction data in real time using the behavior modeling engine 108. The behavior modelling engine 108 may include the at least one machine learning model trained to identify user intent and engagement level.

The at least one processor 202 is configured to determine the contextual relevance score for each of the plurality of predefined dashboard components based on the analyzed user interaction data.

The at least one processor 202 is configured to select the subset associated with the plurality of predefined dashboard components based on the determined contextual relevance score and the user profile.

Upon selecting the subset, the at least one processor 202 is configured to dynamically assemble a personalized analytics dashboard.

The at least one processor 202 is configured to render the personalized analytics dashboard for display to the user via the graphical user interface.

The at least one processor 202 is configured to receive the one or more feedback signals based on user interactions with the displayed personalized analytics dashboard.

The at least one processor 202 is configured to update the behavior modeling engine and the user profile based on the received one or more feedback signals.

FIG. 3A-FIG. 3B illustrate a process flow diagram depicting an exemplary method 300 for real-time generation of the personalized analytics dashboard based on user behavior data, in accordance with an embodiment of the present disclosure. The exemplary method 300 can be implemented at least partially with the system 102, Other implementations may perform the actions in different orders and/or with different, fewer or additional actions than those illustrated in FIG. 3. Multiple actions can be combined in some implementations. For convenience, this flowchart is described with reference to the system 102 that carries out a method. The system is not necessarily part of the method.

FIG. 3A-FIG. 3B include the method 300 that begins at step 302, continuously receiving, at the behavior modeling engine 108, user interaction data from the interactive digital platform. The interaction data may include the at least one user navigation pattern, the at least one user input activity, and the dwell time metric associated with the one or more graphical user interface elements.

The behavior modeling engine 108 collects real-time telemetry from the user interacting with a web or mobile application (interactive digital platform). The user interaction data includes granular activity such as page traversal paths (navigation patterns), direct input events (clicks, typing, selections), and temporal measures such as how long the user stays on or hovers over particular UI elements (dwell time).

For example, the user clicks on a “Revenue by Region” tab→navigation pattern. The user enters a date range into a filter box→input activity. The user hovers for 6 seconds over a forecast chart→dwell time metric.

At step 304, the method 300 may include analyzing, by the behavior modeling engine 108, the user interaction data in real time. The behavior modelling engine may include the at least one machine learning model trained to identify user intent and engagement level.

The behavior modeling engine 108 analyzes user interaction data streams in real time. The behavior modeling engine 108 uses machine learning models such as decision trees, neural networks, or probabilistic classifiers trained to infer user intent (e.g., seeking performance insights vs. anomaly detection) and engagement level (e.g., high interest vs. passive browsing).

In an example, based on repeated filtering of sales KPIs and long dwell times on comparative charts, the behavior modeling engine 108 infers the user is analyzing performance anomalies. A short session with minimal interaction results in the model assigning a low engagement level.

At step 306, the method 300 may include determining the contextual relevance score for each of the plurality of predefined dashboard components based on the analyzed user interaction data.

The system 102 assigns the contextual relevance score to each dashboard component using output from the behavior model, user session metadata, and historical user preferences. The contextual relevance score reflects how useful or interesting the dashboard component is likely to be in the current context.

In an example scenario, a Sales Growth by Region tile gets a score of 0.92 because the user previously spent time on region-level filters. A Marketing Spend Trends graph gets a lower score of 0.21, indicating low predicted interest.

At step 308, the method 300 may include selecting the subset associated with the plurality of predefined dashboard components based on the determined contextual relevance score and the user profile.

The system 102 filters and selects the plurality of predefined dashboard components to show in the personalized analytics dashboard. The subset is chosen based on high contextual relevance scores. User-specific preferences or historical behaviors (stored in the user profile).

In an example scenario, from a pool of 20 predefined dashboard components, the top 7 with the highest relevance scores are selected. A known preference for visualizations over tables biases the selection in favor of graphs.

Upon selecting the subset, at step 310, the method 300 may include dynamically assembling the personalized analytics dashboard.

The selected components are compiled into a dashboard structure. The layout may be determined by component priority, display weight, available screen space, and responsive design principles.

In an example scenario, KPI tiles appear at the top, trend charts below, optional components are collapsed or hidden. On the plurality of user devices 104a, 104b, 104c . . . 104n, fewer components are shown, and vertical scrolling is enabled.

At step 312, the method 300 may include rendering the personalized analytics dashboard for display to the user via the graphical user interface.

The personalized analytics dashboard may be displayed to the user. Rendering may use progressive loading (e.g., high-priority components first), lazy rendering for secondary elements, and graphical enhancements (animations, tooltips) to improve usability.

In few examples, high-relevance “Real-time Revenue Alert” loads first. A “Performance Overview” chart animates into view after initial load.

At step 314, the method 300 may include receiving the one or more feedback signals based on the user interactions with the displayed personalized analytics dashboard.

The system 102 monitors the user behavior data on the displayed dashboard to collect feedback, both explicit and implicit. The feedback signals may include click-through rates, component interactions, time spent per module, or disengagement cues like rapid tab switching.

In an example scenario, user spends 10+ seconds on a Forecast graph→positive engagement signal. The user closes a KPI tile without viewing→potential disinterest or negative signal.

At step 316, the method 300 may include updating the behavior modeling engine 108 and the user profile based on the received one or more feedback signals.

The system 102 uses the feedback signals to refine the models and personalize future sessions. The system 102 may involve retraining or adjusting weights in the machine learning model. The method 300 may include updating the user profile to reflect changing interests or usage habits.

In an example scenario, increase weight of “Forecast Graphs” in relevance scoring for future sessions. Update the user profile to reflect increasing interest in time-based KPIs.

The method 300 may include updating the contextual relevance score at the predefined interaction thresholds using the streaming data pipeline. The streaming data pipeline may be configured with event-time windowing.

The method 300 may include the user profile dynamically incorporates the micro-behaviors derived from the interaction data. The interaction data may include gesture patterns and scroll velocity.

The method 300 may include assigning the flexible display weight and the container priority value to each of the plurality of predefined dashboard components. The personalized analytics dashboard may be dynamically reconfigured by the based on the flexible display weight and the container priority value.

The method 300 may include the one or more feedback signals that include the one or more predictive disengagement indicators. The one or more predictive disengagement indicators may be generated by detecting a decrease in interaction entropy that exceeds a predefined threshold across sequential sections of the personalized analytics dashboard.

The method 300 may include applying the adaptive privacy mechanism that selectively injects differential privacy noise into sensitive features of the captured interaction data. The method 300 may include the sensitive features that are identified based on real-time classification of data sensitivity levels prior to processing by the behavior modeling engine 108.

The method 300 may include partitioning the plurality of predefined dashboard components into the plurality of prioritized rendering segments based on the determined contextual relevance score, and sequentially initiating the rendering of higher-priority segments prior to lower-priority segments.

The method 300 may include correlating one or more detected trends associated with the user behavior data with outputs of one or more anomaly detection models trained on historical deviations in the KPI patterns derived from the prior personalized analytics dashboard.

The method 300 may include generating the plurality of real-time alerts using the predictive insights component based on the correlated one or more detected trends associated with the user behavior data.

The method 300 may include incrementally retraining the behavior modeling engine 108 using a federated learning framework distributed across a plurality of user devices. The method 300 may include the one or more model updates that are computed on the plurality of user devices and securely aggregated by the central server without transmitting raw interaction data.

The methods may be implemented in any suitable hardware, software, firmware, or combination thereof.

Thus, various embodiments of the present invention enable dynamic generation of personalized analytics dashboards in real time, based on continuous analysis of user interaction data. This reduces latency between data access and insight delivery, significantly improving the user's ability to act on relevant information.

The present invention provides a contextual relevance score for each predefined dashboard component using behavior modeling, the system selects only the most contextually relevant data visualizations or KPIs, avoiding information overload and enhancing decision efficiency.

The present invention employs a responsive layout engine that uses component display weights and container priorities to dynamically reconfigure the dashboard presentation across device types, screen sizes, and interaction contexts-providing a seamless cross-platform experience.

The present invention uses the machine learning models for interpreting user intent and engagement allows the system to continuously adapt its behavior to individual user preferences and changing usage patterns without requiring manual configuration.

The present invention incrementally updates the behavior modeling engine and user profile. The present invention facilitates a continuously learning and evolving system that tailors future dashboards with increasing accuracy.

The present invention implements with federated learning, the system can incrementally retrain models using user behavior patterns without transferring raw interaction data, thereby preserving user privacy while maintaining model accuracy and adaptability.

The present invention applies differential privacy noise selectively to interaction features based on real-time classification of data sensitivity. This enhances user trust and compliance with data protection regulations.

The present invention decomposes dashboard components into progressive rendering segments, prioritized by real-time relevance score. The present invention reduces perceived load time and enables users to interact with high-priority insights sooner, improving UX in bandwidth-limited environments.

The present invention includes a predictive insights component that correlates behavior trends with the output of anomaly detection models trained on KPI deviations, enabling proactive alerts and early identification of performance issues or operational risks.

The present invention allows individual components-such as the behavior modeling engine, relevance scoring module, or rendering engine—to be updated or scaled independently, improving maintainability and deployment flexibility.

Examples of the techniques and system described herein include, but are not limited to, the following enumerated embodiments:

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for real-time generation of a personalized analytics dashboard based on user behavior data, the method comprising:
continuously receiving, at a behavior modeling engine, user interaction data associated with the user behavior data from an interactive digital platform, wherein the interaction data comprises at least one user navigation pattern, at least one user input activity, and a dwell time metric associated with one or more graphical user interface elements;
analyzing, by the behavior modeling engine, the user interaction data in real time, wherein the behavior modelling engine comprising at least one machine learning model trained to identify user intent and engagement level;
determining a contextual relevance score for each of a plurality of predefined dashboard components based on the analyzed user interaction data;
selecting a subset associated with the plurality of predefined dashboard components based on the determined contextual relevance score and a user profile;
upon selecting the subset, dynamically assembling the personalized analytics dashboard;
rendering the personalized analytics dashboard for display to a user via a graphical user interface;
receiving one or more feedback signals based on user interactions with the displayed personalized analytics dashboard; and
updating the behavior modeling engine and the user profile based on the received one or more feedback signals.

2. The method of claim 1, wherein the behavior modeling engine comprises a hybrid model architecture combining a real-time rule-based engine with a long short-term memory (LSTM) neural network to adaptively model user behavior transitions across different sessions.

3. The method of claim 1, comprising:
updating the contextual relevance score at predefined interaction thresholds using a streaming data pipeline, wherein the streaming data pipeline configured with event-time windowing.

4. The method of claim 1, wherein the user profile dynamically incorporates micro-behaviors derived from the interaction data, wherein the interaction data comprises gesture patterns and scroll velocity.

5. The method of claim 1, further comprising:
assigning a flexible display weight and a container priority value to each of the plurality of predefined dashboard components, wherein the personalized analytics dashboard is dynamically reconfigured by the behavior modeling engine based on the flexible display weight and the container priority value.

6. The method of claim 1, wherein the one or more feedback signals comprise one or more predictive disengagement indicators, wherein the one or more predictive disengagement indicators are generated by detecting a decrease in interaction entropy that exceeds a predefined threshold across sequential sections of the personalized analytics dashboard.

7. The method of claim 1, further comprising:
applying an adaptive privacy mechanism that selectively injects differential privacy noise into sensitive features of the captured interaction data, wherein the sensitive features are identified based on real-time classification of data sensitivity levels prior to processing by the behavior modeling engine.

8. The method of claim 1, wherein rendering the personalized analytics dashboard comprises:
partitioning the plurality of predefined dashboard components into a plurality of prioritized rendering segments based on the determined contextual relevance score, and sequentially initiating the rendering of higher-priority segments prior to lower-priority segments.

9. The method of claim 1, wherein rendering the personalized analytics dashboard comprises:
correlating one or more detected trends associated with the user behavior data with outputs of one or more anomaly detection models trained on historical deviations in key performance indicator (KPI) patterns derived from a prior personalized analytics dashboard; and
generating a plurality of real-time alerts using a predictive insights component based on the correlated one or more detected trends associated with the user behavior data.

10. The method of claim 1, further comprising:
incrementally retraining the behavior modeling engine using a federated learning framework distributed across a plurality of user devices, wherein one or more model updates are computed on the plurality of user devices and securely aggregated by a central server without transmitting raw interaction data.

11. A system for real-time generation of a personalized analytics dashboard based on user behavior data, the system comprising:
at least one memory;
at least one processor operatively connected to the at least one memory, wherein the at least one processor is configured to:
continuously receive, at a behavior modeling engine, user interaction data associated with the user behavior data from an interactive digital platform, wherein the interaction data comprises at least one user navigation pattern, at least one user input activity, and a dwell time metric associated with one or more graphical user interface elements;
analyze the user interaction data in real time using the behavior modeling engine, wherein the behavior modelling engine comprising at least one machine learning model trained to identify user intent and engagement level;
determine a contextual relevance score for each of a plurality of predefined dashboard components based on the analyzed user interaction data;
select a subset associated with the plurality of predefined dashboard components based on the determined contextual relevance score and a user profile;
upon selecting the subset, dynamically assemble the personalized analytics dashboard;
render the personalized analytics dashboard for display to a user via a graphical user interface;
receive one or more feedback signals based on user interactions with the displayed personalized analytics dashboard; and
update the behavior modeling engine and the user profile based on the received one or more feedback signals.

12. The system of claim 11, wherein the behavior modeling engine comprises a hybrid model architecture combining a real-time rule-based engine with a long short-term memory (LSTM) neural network to adaptively model user behavior transitions across different sessions, and wherein the one or more feedback signals comprise one or more predictive disengagement indicators, wherein the one or more predictive disengagement indicators are generated by detecting a decrease in interaction entropy that exceeds a predefined threshold across sequential sections of the personalized analytics dashboard.

13. The system of claim 11, wherein the at least one processor is configured to:
update the contextual relevance score at predefined interaction thresholds using a streaming data pipeline, wherein the streaming data pipeline configured with event-time windowing.

14. The system of claim 11, wherein the user profile dynamically incorporates micro-behaviors derived from the interaction data, wherein the interaction data comprises gesture patterns and scroll velocity.

15. The system of claim 11, wherein the at least one processor is configured to:
assign a flexible display weight and a container priority value to each of the plurality of predefined dashboard components, wherein the personalized analytics dashboard is dynamically reconfigured by the behavior modeling engine based on the flexible display weight and the container priority value.

16. The system of claim 11, wherein the at least one processor is configured to:
apply an adaptive privacy mechanism that selectively injects differential privacy noise into sensitive features of the captured interaction data, wherein the sensitive features are identified based on real-time classification of data sensitivity levels prior to processing by the behavior modeling engine.

17. The system of claim 11, wherein the at least one processor is configured to render the personalized analytics dashboard comprises:
partition the plurality of predefined dashboard components into a plurality of prioritized rendering segments based on the determined contextual relevance score, and sequentially initiating the rendering of higher-priority segments prior to lower-priority segments.

18. The system of claim 11, wherein the at least one processor is configured to render the personalized analytics dashboard comprises:
correlate one or more detected trends associated with the user behavior data with outputs of one or more anomaly detection models trained on historical deviations in key performance indicator (KPI) patterns derived from a prior personalized analytics dashboard; and
generate a plurality of real-time alerts using a predictive insights component based on the correlated one or more detected trends associated with the user behavior data.

19. The system of claim 11, wherein the at least one processor is configured to incrementally retrain the behavior modeling engine using a federated learning framework distributed across a plurality of user devices, wherein one or more model updates are computed on the plurality of user devices and securely aggregated by a central server without transmitting raw interaction data.

20. A non-transitory computer-readable medium storing instructions that, when executed, cause a processor to:
continuously receive, at a behavior modeling engine, user interaction data associated with a user behavior data from an interactive digital platform, wherein the interaction data comprises at least one user navigation pattern, at least one user input activity, and a dwell time metric associated with one or more graphical user interface elements;
analyze the user interaction data in real time using the behavior modeling engine, wherein the behavior modelling engine comprising at least one machine learning model trained to identify user intent and engagement level;
determine a contextual relevance score for each of a plurality of predefined dashboard components based on the analyzed user interaction data;
select a subset associated with the plurality of predefined dashboard components based on the determined contextual relevance score and a user profile;
upon selecting the subset, dynamically assemble a personalized analytics dashboard;
render the personalized analytics dashboard for display to a user via a graphical user interface;
receive one or more feedback signals based on user interactions with the displayed personalized analytics dashboard; and
update the behavior modeling engine and the user profile based on the received one or more feedback signals.
